(19) United States
(12) Patent Application Publication
(10) Pub. No.: US 2006/0100790 A1
(43) Pub. Date: May 11, 2006

(54) Methods for providing a nucleotide sequence information protection service

(76) Inventors: Patrick J. Downs, Lake San Marcos, CA (US); Daniel C. Downs, Lake San Marcos, CA (US); John Falliers, Newport Beach, CA (US)

Correspondence Address: GORDON & REES LLP, 101 WEST BROADWAY, SUITE 1600, SAN DIEGO, CA, 92101, US

(21) Appl. No.: 10/982,467

(22) Filed: Nov. 5, 2004

(51) Int. Cl. G06Q 10/00; G06F 19/00

(52) U.S. Cl. 702/20; 705/2

(57) ABSTRACT

Methods are provided for a protecting an individual's genetic information, particularly an individual's nucleotide sequence information. According to these methods, a service provider obtains nucleotide sequence information for an individual, enters the information into a database, and seeks protection for the individual's nucleotide sequence information, especially copyright protection.

### FIELD OF THE INVENTION

The invention relates generally to methods for protecting personal genetic information. Particularly, the present invention provides methods for providing a nucleotide sequence information protection service.

### BACKGROUND OF THE INVENTION

Recently, sequencing of the human genome has provided information about the genetic make-up of humans. The ease with which DNA sequencing can now be conducted has also made the genetic information of individuals more readily accessible. Genetic research has made it possible to identify genes associated with the occurrence of diseases and medical conditions. Advances in DNA sequencing have made it possible to determine the presence of sequence variations or polymorphisms in these genes that may indicate predisposition to diseases or medical conditions. The fields of “pharmacogenomics” (the study of the genes that affect drug metabolism and effect) and “pharmacogenetics” (the study of how drug response is inherited by individuals) has sparked great interest in the pharmaceutical industry, with the promise that more effective and efficient drug therapies can be developed and appropriate drugs can be selected for individual patients. Nucleotide sequence information has also been used in forensic investigations to uniquely identify individuals (both criminals and victims of crime) based on biological evidence.

There is concern, however, that the same genetic information and nucleotide sequence information that makes it possible to determine predisposition for diseases should remain the property of the individual rather than being improperly misappropriated by organizations seeking to profit from such information without the individual's consent. Moreover, the misuse of genetic information in the forensic context can lead to false accusations and even loss of liberty. Unauthorized or improper use of genetic information may lead to misidentification of individuals in ways that can impact such important areas of life as child paternity, ancestry, inheritance, medical coverage and insurance. Thus, there is a need for methods that protect the rights of the individual in controlling privacy by preventing exploitation and the use of his or her own genetic information.

The interest in personal genetic information has given rise to businesses ventures such as Orchid BioSciences and Genaissance Pharmaceuticals that provide analysis of the differences in genetic information, or nucleotide polymorphisms, between individuals. Large forensic laboratories, such as Cellmark, have also grown in response to law enforcements requirements to identify the source of biological evidence. Unfortunately, these services are primarily directed toward institutional or industrial clients and are largely unavailable to the general public.

The few companies that exist to serve the individual consumer generally provide only a limited range of services. For example, companies such as “Childs ID Inc.” offer do-it-yourself kits that may be used to take samples of such biological materials as saliva, which can be stored for use in the event of a missing child or an adult disappearance. Such products offer little genetic information to the individual and typically are not used in a manner that establishes a chain of custody. Genetic testing laboratories can analyze individuals for medically relevant genes, but typically only in response to a medical diagnosis and upon the request of a physician.

One company that has responded to the need for individual genetic information protection is DNA Copyright Institute. This company advocates copyrighting an individual's DNA and will assist in making a limited analysis based on 13 single tandem repeat polymorphisms or STRs. However, the DNA Copyright Institute does not, in fact, provide assistance in obtaining U.S. Copyright resgistration, or any other legal protection. Neither does the Institute provide a secure repository for biological samples in the event that additional testing is required.

Thus, there is need to provide consumers with a broad range of genetic protection services including both physical and legal protections. Furthermore, individuals may require access to sophisticated nucleotide sequence analyses to permit personal identification and prevent misuse of their genetic information. The individuals may further benefit from maintaining the physical sample and data regarding test results in an organized, secure database environment. Access to the is database may permit the individuals to utilize this data for future benefit, for example, in obtaining improved delivery of health services or in providing independent verification of personal identity for family services such as paternity and descendancy verification. Finally, there is a need to provide methods for controlling the coordination, compilation and distribution of the nucleotide sequence information of a large number of individuals for the purposes of research and commercialization that preserves the privacy of the individual, permits the individual to maintain control of his own genetic information and provides a means for the financial or other benefit of the information to bear directly on that individual.

### SUMMARY OF THE INVENTION

The present invention is directed to methods for providing a personal nucleotide sequence information protection service to an individual comprising:
a) obtaining nucleotide sequence information for an individual;
b) entering the information into a database; and
c) seeking protection for the nucleotide sequence information, wherein the method is carried out by a service provider.

Also provided by the invention is a method for providing a nucleotide sequence information protection service to an individual that comprises:
a) entering into an agreement with the individual to provide protection services for a fee;
b) obtaining a biological sample from the individual;
c) obtaining nucleotide sequence information from the biological sample;
d) storing and indexing the nucleotide sequence information in a database record;
e) storing supplementary information regarding the individual in a way that associates the supplementary information with the nucleotide sequence information;
f) maintaining the database;
g) retaining the biological sample, a polynucleotide sample derived therefrom, or any unused portions thereof, under conditions that preserve polynucleotides;
h) seeking protection of the nucleotide sequence information; and
i) providing a value added package to the individual, wherein the service to an individual is provided by a service provider.

In an alternative embodiment of the invention, a method for providing a personal nucleotide sequence copyright protection service to an individual is provided This method comprises:
a) entering into an agreement with an individual to provide services regarding the individual's personal nucleotide sequence for a fee;
b) obtaining a biological sample from the individual;
c) obtaining nucleotide sequence information from the biological sample;
d) storing and indexing the nucleotide sequence information in a database record;
e) storing supplementary information regarding the individual in a way that associates the supplementary information with the nucleotide sequence information;
f) maintaining the database;
g) retaining the biological sample, a polynucleotide sample derived therefrom, or any unused portions thereof, under conditions that preserve polynucleotides;
h) submitting an application for copyright registration of an expression of the individual's nucleotide sequence to the United States Copyright Office;
i) storing and indexing copyright information regarding the expression of the individual's nucleotide sequence in the individual's database record;
j) providing a value added package to the individual, wherein the service to an individual is provided by a service provider.

This embodiment can also include the additional steps of:
a) obtaining the individual's medical record history;
b) storing and indexing the medical record history in the individual's database record in a way that associates the medical record history with nucleotide sequence information and supplementary information about the individual;
c) obtaining permission from the individual to provide access to the individual's information in the database to third parties; and
d) providing access to the database to third parties, subject to confidentiality and anonymity restrictions.

### DETAILED DESCRIPTION OF THE INVENTION

The present invention relates to methods for providing a personal nucleotide sequence information protection service to an individual, comprising the steps of a) obtaining nucleotide sequence information from an individual; b) entering the information into a database, and c) protecting the nucleotide sequence information.

In general, the methods of this invention are carried out by or under the direction of a “service provider.” The service provider may, without limitation, be an individual, a partnership, a corporation, a consortium, a government agency, a non-profit organization or any other person or group of people who carry out the services or activities set forth herein. Services offered by the service provider may be performed directly by the service provider, his employees, agents or assigns. Alternatively, services offered by the service provider may be performed by entities which provide said services for or on behalf of the service provider. For example, the service provider may contract with an independent contractor or other vendor to provide one or more of the services described herein.

The activities of the service provider may include, but are not limited to the following:
a) Entering into agreements with individuals regarding the individuals genetic information;
b) Collecting compensation for the service provider's activity for the individuals;
c) Assigning an identification code to the individuals;
d) Indexing the identification code into a database;
e) Obtaining a biological sample from the individual;
f) Isolating a DNA or other polynucleotides from the biological sample;
g) Obtaining nucleotide sequence information from the biological sample;
h) Compiling the nucleotide sequence information from the biological sample;
i) Indexing the individual's nucleotide sequence information into the database;
j) Maintaining the database;
k) Retaining the biological sample used for sequence determination and/or at least one polynucleotide sample derived from the biological sample;
l) Providing to the individual a notice indicating the protected status of the nucleotide sequence information;
m) Obtaining patent protection for the nucleotide sequence;
n) Providing trade secret protection for the nucleotide sequence;
o) Obtaining copyright protection for the nucleotide sequence;
p) Determining the nature of the method of analyzing the nucleotide sequence;
q) Obtaining the medical history of the individual;
r) Correlating the medical history with the nucleotide sequence information for the individual;
s) Obtaining permission from the individual to provide access to his or her database;
t) Providing access to the database to authorized third parties.

In one embodiment of invention, nucleotide sequence information is obtained from an individual by obtaining a biological sample from the individual and analyzing the nucleotide sequence of at least one polynucleotide in the biological sample. The biological sample may be obtained in any suitable manner. The biological sample is usually obtained by drawing a sample of blood, but can be obtained in any other way that will permit the analysis of the individual's nucleotide sequence. Thus, the sample may be obtained from a bodily fluid such as urine, saliva, or semen. Alternatively, the sample may be a tissue sample, hair sample or any other sample from the individual that contains genetic information, such as nuclear genetic information. Any manner or technique that will allow obtaining a sample that can be used to obtain genetic information regarding the individual may be utilized. In a preferred embodiment, the sample is obtained by drawing blood in sufficient quantity to permit one portion of the sample to be analyzed for nucleotide sequence and also provide another portion to be retained for subsequent additional analyses. Typically, at least about 5-10 mL of blood will be obtained.

In one aspect of the invention, the biological sample and subsequent analyses are performed while establishing and documenting the chain of custody of the sample.

In accordance with the present invention, the biological sample is used to obtain genetic information regarding the individual. The genetic information of an individual is stored in DNA polynucleotides, segments of which may be transcribed in a cell into RNA polynucleotides. In one embodiment of the invention, one or more these polynucleotides is isolated from the biological sample. Typically, DNA is isolated from the biological sample. The DNA can be isolated from the biological sample by any convenient means. Methods for isolating DNA suitable for use in sequence determination of polymorphisms are well known in the art. For example, DNA isolation methods are described in Ausubel et al., (eds.) Current Protocols in Molecular Biology, (1994) John Wiley & Sons, New York. Conveniently, reagents and kits for isolating DNA suitable for nucleotide sequence analysis are commercially available. For example the Puregene™ DNA and RNA purification kits from Gentra Systems (Minneapolis, Minn.) have been designed for the preparation of archival quality nucleic acids from such biological samples as blood, tissue, and bodily fluids, including dried smears thereof. Alternatively, techniques for obtaining genetic information that do not require isolation of a polynucleotide from the biological sample may be used.

Analysis of the nucleotide sequence of the individual's polynucleotides can be performed using any appropriate method. In one embodiment, the nucleotide sequence of DNA is determined directly using chemical cleavage (Maxam & Gilbert, Proc. Natl. Acad. Sci. U S A. 74:560-4 (1977)) or dideoxy chain termination (Sanger et al., Proc. Natl. Acad. Sci. U S A. 74:5463-67 (1977)) methods that are well known in the art. Conveniently, automated DNA sequence analysis can be performed, for example, using commercially available instrumentation and reagents such as the MegaBase sequencing system (Amersham Biosciences, Piscataway, N.J.). Typically, the amount of nucleotide sequence information required is an “identifying number” of nucleotides, which is a sufficient number of nucleotides to permit unambiguous discrimination of the individual from any other individual in the world population. In one aspect of the invention, the nucleotide sequence of the individual's entire genome is determined. It will be understood by the skilled artisan, however, that the nucleotide sequence of only a fraction of the genome will be required to make an unambiguous identification of the individual.

In accordance with the present invention, analysis of the individual's nucleotide sequence will generally involve detecting only the nucleotide sequence at a limited number polymorphic loci. Polymorphic loci in mammalian genomes have long been used to distinguish between individual members of the same species. “Polymorphism,” as used herein, describes the regular occurrence in a population of two or more forms or alleles of a polynucleotide sequence where the frequency of the rarer forms is greater than can be explained by spontaneous mutation alone (typically greater than 1%). Polymorphism can, without limitation, result from deletions, insertions, duplications, or substitutions of one or more nucleotides. “Single nucleotide polymorphisms” or “SNPs” are polymorphic nucleotide sequences in which the purine or pyrimidine base at a single nucleotide position has been replaced by another purine or pyrimidine base. SNPs are the most common form of polymorphism in the human genome, occurring at a frequency of approximately 1 per 1000 base pairs. Analysis of known polymorphisms in general and SNPs in particular provides an efficient means of identifying a large number of differences between individuals, thereby permitting unambiguous identification of one individual with the least amount of sequence analysis. Any type of polymorphism, including but not limited to single nucleotide polymorphisms, restriction fragment length polymorphisms, and single tandem repeat polymorphisms, is a suitable target for analysis according to the methods of the present invention.

A variety of methods have been developed to detect polymorphisms and other differences between the nucleotide sequences of two individuals. For example, deletions and rearrangements of large sections of chromosomes can be detected ctyologically and/or by fluorescence in situ hybridization (FISH) (see e.g., U.S. Pat. No. 5,472,842 the disclosure of which is incorporated herein by reference; reviewed in Gray et al., Prog Clin Biol Res., 372:399-411 (1991). Individual nucleotide changes can be detected by direct sequencing of the region of polymorphic changes. However, this method is labor intensive time consuming and expensive. A variety of methods have been developed to detect polymorphisms, particularly SNPs, that rely on an indirect property of the nucleotide differences. When a polymorphism occurs within a restriction endonuclease recognition site, for example, the products of restriction endonuclease digestion of polymorphic DNA are affected. Restriction fragment length polymorphisms or RFLPs can be detected using electrophoretic analysis of the differences in the length of restriction fragments generated from nucleotide sequences with different polymorphisms (see e.g., Hyldig-Nielsen et al., , Proc. Natl. Acad. Sci. U.S.A. 84:1644-1648 (1987)). Nucleotide changes also affect the physical properties of polymorphic regions of the polynucleotide. Thus, polymorphisms can frequently be detected using such methods by single strand conformational polymorphism (SSCP) analysis (Orita et al., Genomics 5:874-879 (1989)) and heteroduplex analysis (see e.g., Nagamine et al, Am. J Hum. Genet. 45, 337-339 (1989)).

In general, any means which will provide nucleotide sequence information may be employed. Alternative embodiments of the present invention will employ SSCP analysis, RFLP analysis, heteroduplex analysis, mass spectrometry, primer extension, a nucleic acid array or microarray, nucleic acid gel electrophoresis, nucleic acid hybridization, nucleic acid bending analysis, or a combination thereof, in identifying nucleotide sequence polymorphisms. (For review of techniques for polymorphism analysis see e.g., Rose et al., Methods Mo.l Med. 85:225-37 (2003)). Particularly suitable techniques include without limitation, those which permit the simultaneous determination of a panel of SNPs (e.g, multiplex techniques) and those that can be performed rapidly with high-throughput (see e.g., Shi, Clin. Chem. February;47(2):164-72 (2001); Jurinke et al, Adv. Biochem. Eng. Biotechnol. 7:57-74 (2002)). Typically, methods of the present invention will employ at least one technique for amplifying the polymorphic loci of interest, preferably utilizing polymerase chain reaction methods that are well-known in the art. Examples of appropriate amplification procedures for use in the present invention include, but are not limited to: cloning (Sambrook et al., Molecular Cloning: A Laboratory Manual, Cold Spring Harbor Laboratory Press, (1989)); polymerase chain reaction (PCR) (C. R. Newton and A. Graham, PCR, BIOS Publishers (1994)); ligase chain reaction (LCR) (Wiedmann, et al., PCR Methods Appl. Vol. 3:57-64 (1994)); Barnay, Proc. Natl. Acad. Sci USA 88, 189-93 (1991)); strand displacement amplification (SDA) (Walker et al., Nucleic Acids Res. 22, 2670-77 (1994)); and variations such as RT-PCR (Higuchi et al., Bio/Technology 11:1026-1030 (1993)).

In one embodiment of the invention, amplification involves the use of the MassEXTEND™ methodology developed by Sequenom (San Diego, Calif.; see, e.g., in U.S. Pat. Nos. 6,602,662; 6,500,621; 6,428,955; 6,300,076; 6,277,573; 6,268,144; 6,258,538; 6,235,478; 6,221,605; 6,221,601; 6,197,498; 6,043,031; and 5,605,798; the entire disclosures of which are incorporated herein by reference). In one aspect of this embodiment, polymorphism analysis utilizes Sequenom's patented MassARRAY™ System of MALDI-TOF mass spectrometry. Id.

Polymorphism exists in both RNA coding and non-coding regions of the genome. Polymorphisms in RNA coding regions may affect the amino acid sequence of the encoded protein, which in turn may affect the function of that protein. Particularly useful polymorphisms have been correlated to clinically relevant phenotypes, including predisposition to disease and response to treatment with a drug. The pharmaceutical industry has recently shown great interest in “pharmacogenomics” and “pharmacogenetics” or the correlations between genetics and drug response. (See e.g., Pagliarulo et al., Curr. Issues. Mol. Biol. 4:101-10 (2002); Ma et al., Am, J. Health Syst, Pharm. 59:2061-9 (2002); Shi, Am. J. Pharmacogenomics, 2:197-205 (2002)). Pharmacogenomics and pharmacogenetics offer great promise in predicting the outcome of a patient to a course of therapy, and is therefore envisioned as an important tool for future physicians in prescribing one course of treatment versus another for myriad diseases. Accordingly, in one embodiment of the present invention, the nucleotide sequence of polymorphic loci associated with the propensity for a disease or the response to drug therapy are determined. According to one aspect of this embodiment, the analysis of the individual's nucleotide sequence provides sufficient information to allow identification of a propensity for a medical condition. For some conditions, a single SNP may provide sufficient indication of disease propensity, while more complex conditions may require a determination polymorphisms at multiple sites in the genome.

The number of polymorphisms that must be analyzed generally depends on the “power of exclusion” for the particular polymorphic sites employed. The power of exclusion describes the ability of a test (e.g. polymorphism detection) to exclude false positive identification of an individual. The average or expected power of exclusion can be estimated using gene frequency distributions of systems in Hardy-Weinberg equilibrium (Brenner & Morris, “Paternity Index Calculations in Single Locus Hyper-Variable DNA Probes: Validation and Other Studies,” Proceedings for The International Symposium on Human Identification, pp. 21-76 (1989)), or by computing methods (Chakravarti et al., Am. J. Hu. Genet., 26:477-488 (1974); Garber & Morris, “General Equations for the Average Power of Exclusion for Genetic Systems of n Codominant Alleles in One-Parent and No-Parent Cases of Disputed Parentage,” in Inclusion Probabilities in Parentage Testing, pp. 277-280 (1983); Chakravarti & Li “The Effect of Linkage on Paternity Calculations,” in Inclusion Probabilities in Parentage Testing, pp. 411-422 (1983)). For paternity determination, typically, analysis of at least nine short tandem repeat polymorphisms (STRs) is performed. At least about 18 typical SNP or STR polymorphisms should be analyzed to allow unambiguous identification of individuals. For identification purposes, it is desirable to have data of sufficient selected SNPs or STRs to provide unambiguous information to establish individual identification (i.e., an identifying number of polymorphisms). Furthermore, the polymorphic sites should be selected for the utility in providing data to support identification. According to the present invention, an “identifying number” of polymorphisms is generally at least about 18 selected polymorphisms, preferably at least about 35 selected polymorphisms, more preferably at least about 70 selected polymorphisms, and most preferably, at least about 100 selected polymorphisms.

The number of polymorphisms required for determining propensity for medical conditions can vary from at least I to at least about 30 selected polymorphisms. In general, it is desirable to obtain information regarding enough polymorphisms to provide a comprehensive indication of the propensity for disease. Preferably, at least about 70 selected polymorphisms will be analyzed and in some cases, analysis of at least about selected 100 polymorphisms is be desirable.

Additional polymorphisms continue to be identified in the human genome and correlated with medical conditions and therapeutic responses. Furthermore, the individual may subsequently develop a medical condition for which polymorphism analysis would be useful. Thus, it will be advantageous to retain biological samples and/or polynucleotides isolated from the biological samples, particularly unused portions of the individual's biological sample, that can be analyzed in the future for additional diagnostic polymorphisms. Preferably, the biological sample and/or polynucleotides isolated from the biological samples, will be frozen or otherwise stored under conditions that preserve the polynucleotides therein.

The methods of the present invention provide for entering the individual's nucleotide sequence into a database, such as a computer database. The database may be developed, implemented and maintained by any available method, including the use of commercial database software, such as Paradox, SQL, Oracle or LIMS. Alternatively, a proprietary database created specifically for use in the methods of the present invention may be used. Entry of the nucleotide sequence information into the database will typically create a database “record” that may be associated with an identification code, which can involve the use of any appropriate code. The code can comprise or include the name of the individual. In a preferred embodiment, the individual's database record is “anonymized” by assigning a code comprised of random letters, numbers or other symbols, such as, for example, a barcode. In general, the code will be maintained in a manner to provide for confidentiality.

Indexing the code into the database can be carried out using any standard indexing or correlating procedures. The database record may include supplemental information about the individual, including but not limited to, regarding the individual's name, date of birth, contact information, sex, ethnic background, medical history, physical description, genealogy and the like. The individual's medical history can include such information as height, weight, heart rate, blood pressure, blood type, laboratory and other medical test results, current medical conditions, previous incidents of disease, injury or disability, drug or other allergies, surgical records, family history of illness, cause of death of one or more family members, and the like.

According to the methods of the present invention, the services provided include protection of the individual's nucleotide sequence information, including but not limited to legal protection, physical protection, or a combination thereof. In one embodiment of the invention, the protection provided is aimed at deterring the unauthorized conduct of third parties, particularly the use, misuse, distribution, duplication, reproduction, modification, derivation and/or commercial development of the individual's nucleotide sequence information. Moreover, the specific physical and/or legal protections of the invention can be tailored to the needs of the individual. Thus, an individual opposed to human cloning may especially require deterrence of the unauthorized cloning of the individual's cells, tissues, or genetic material. Accordingly, the methods of the present invention provide, without limitation, deterrence of such occurrences as false criminal accusations, improper denial of medical or insurance coverage, misidentification of the individual, misidentification of the individual's relatives, exploitation or commercialization of the individual's biological material or nucleotide sequence information without informed consent, and unauthorized cloning of the individual's cells, tissues, or genetic material.

The interests of the individual may, in large measure, be protected by methods of the invention that establish and maintain a physically secure and confidential environment for the individual's nucleotide sequence information and retained biological samples or polynucleotides. The secure and confidential environment can be provided by taking such steps as “anonymizing” the sequence information by assigning an identification code that can be used in place of personal information about the individual; using security passwords for database and computer access; encrypting the database records, codes and passwords; limiting access to the sequence information and biological samples; requiring non-disclosure agreements of all personnel having access to the sequence information obtained from the biological samples; and securing the sequence information and biological sample storage facilities from unauthorized entry.

Although the nucleotide sequence information code can comprise or include the name of the individual, for the purposes of anonymity, the code will typically be a random selection of letters, numbers or other symbols. For example, a barcode may be employed. In general, the code will be maintained in a manner to provide for confidentiality. Indexing the code into the database can be carried out using any standard indexing or correlating procedures.

In some instances, the establishment of a legal record of the individual's identifying nucleotide sequence information may provide sufficient protection for the individual against such occurrences as the possible misidentification of the individual, or disputes over paternity. Similarly, an identifying nucleotide sequence record can prove useful in determination of sibship, descendancy, national origin or ethnic origin of the individual. High-profile individuals concerned with kidnapping of themselves or their loved ones or associates may find especially comforting the ability to identify themselves or family members or associates based on the nucleotide sequence information obtained from a biological sample. The legal record may, for example, be lo an authenticated record of the nucleotide sequence information of the individual and preferably, will comprise a record of the chain of custody such that the legal record can be used as evidence in a court or other legal proceeding.

The current invention anticipates that additional legal protection may be required by some individuals. Such protections are provided by way of trade secret protection, patent protection and copyright protection.

After the nucleotide sequence information has been obtained, for example, patent protection may be applied for to protect the nucleotide sequence from improper use. It will be readily apparent to those skilled in the art that a variety of strategies for patent protection can be employed. In one embodiment of the invention, protection may involve isolating and purifying a patentable polynucleotide from the biological sample. In this embodiment of the invention, nucleotide sequence information provided by the methods of the invention along with, e.g., pharmacogenetic or pharmacogenomic correlations, may facilitate the steps required for patenting a polynucleotide. In alternative embodiments, patent protection may be sought on a composition of the polynucleotide, methods of using the composition information, methods of obtaining the composition information, instrumentation used in obtaining and using the composition information and other forms of patent protection well known to those skilled in the art. Typically, patent protection will involve filing an application for patent with the United States Patent and Trademark Office and may optionally include international patent filings.

As an alternative to patent protection, the nucleotide sequence information can be protected as a trade secret by taking reasonable steps to maintain the secrecy of the nucleotide sequence information. Such steps may include, for example, anonymizing the sequence information, encrypting the database records, limiting access to the sequence information, requiring non-disclosure agreements of all personnel having access to the sequence information (particularly when the information is used), limiting the use of the information, and other appropriate safeguards for protecting trade secret information known to those skilled in the art.

Copyright protection may also be employed to protect an individual's nucleotide sequence information. Various compilations and expressions of information in tangible media may be created using the methods and equipment used for sequencing the polynucleotide and for correlating polynucletide sequence information with medical records. Copyright protection may be applied for and obtained on such compilations and fixed expressions of information and data. Non-limiting tangible forms of expression may include the computer database record and associated correlations, as well as more mundane expressions such as plaques, certificates, articles of clothing, and identification cards. The form of application for copyright protection is well known to those skilled in the art and all such methods may be employed in protecting the polynucleotide sequence information and correlations of that information with other data and information according to the present invention. In a preferred embodiment of the invention, the copyright protection involves filing for United States Copyright registration, and may include supplemental United States Copyright filings, wherein the supplemental United States Copyright filings seek protection for nucleotide sequence and polymorphism analyses not protected by early filings. Application for federal copyright registration is made using a statutory procedure, a description of which can be found at http://www.copyright.gov. To safeguard the rights of the individual in copyright, the United States Copyright registration may be assigned to the individual and the assignment recorded with the United States Copyright Office. It may be desirable, however, for the service provider to retain the right to sublicense the copyright with the individual's consent.

Optionally, the methods of the present invention include providing the individual with a notice indicating the protected status of the individual's nucleotide sequence information. The notice may include such information as copyright registration information for the nucleotide sequence as well as statements that the nucleotide sequence information is protected by application for a patent and is protected in a database. In one embodiment of the invention, the inventors contemplate that the notice may be distributed to prevent unauthorized use of the individual's DNA sample or nucleotide sequence information.

According to another embodiment, the present invention encompasses a method for providing nucleotide sequence information protection service to an individual, said method comprising:
a) entering into an agreement with the individual to provide protection services for a fee;
b) obtaining a biological sample from the individual;
c) obtaining nucleotide sequence information from the biological sample;
d) storing and indexing the individual's nucleotide sequence information in a database record;
e) storing supplementary information regarding the individual in a way that associates the supplementary information with the individual's nucleotide sequence information;
f) maintaining the database;
g) retaining the biological sample, at least one polynucleotide sample derived therefrom, or any unused portion thereof, under conditions that preserve polynucleotides;
h) seeking protection of the nucleotide sequence information; and
i) providing a value added package to the individual; wherein the service to an individual is provided by a service provider.

The agreement between the service provider and the individual may provide for the service provider to carry out any one or more of the services set forth in items (b)-(i) set forth above. In return for those services, the individual will typically provide the service provider with at least one of the following:
a) A fee for the services;
b) A biological sample;
c) A family history;
d) A medical history;
e) A power of attorney for securing patent, copyright or other types of protection;
f) An assignment of rights to bargain with entities providing medical services to the individual;
g) And any other rights which will facilitate the service provider in obtaining genetic information regarding the individual, maintaining said information and utilizing that information for protection, research or and profit.

The agreement between the service provider and the individual may be any type of agreement, either written or oral. When recorded, the agreement can be recorded on any type of medium. In general, the agreement will be in a form which is legally enforceable by both the service provider and the individual. In one embodiment of the invention, the agreement provides for the individual's consent to provide a biological sample for nucleotide sequence determination. In another embodiment of the present invention, the agreement provides that the service provider agrees to maintain the confidentiality of the information. In alternative embodiments, the agreement may also provide that the service provider agrees to apply for federal copyright registration or patent protection or other types of protection. The agreement may further provide for the individual agreeing to provide notice to anyone obtaining access to his or her biological samples of the protected status of his or her nucleotide sequence information. The agreement may further provide permission to the service provider to provide access to an individual's information or biological samples to third parties, such as, for example where the nucleotide sequencing or polymorphism determination is performed by a third party. In such cases, the biological sample will typically be identified by the individual's identification code when conveyed to a third party, and the chain of custody record will be maintained.

The agreement may also provide for the service provider to act as an agent for the individual. The agreement to grant agency may include allowing the service provider to carry out handling, storage, administration, maintaining security and confidentiality, licensing and additional testing of nucleotide sequence information and biological samples, for example, by anonymizing the database record by assigning the individual an identification code to protect the individual's anonymity.

The agreement may also provide for the individual's proof of personal identity and consent to provide a biological sample.

In one embodiment of the invention, the individual is provided with a form of agreement not to make any unauthorized use of the individual's DNA. In general, such agreement should be executed by any entity before it is permitted to obtain a biological sample, DNA, nucleotide sequence information or other confidential material from the individual. Preferably, the agreement will require that the entity not make any unauthorized analysis of the individual's biological sample or information, carry out only specified analyses, and ensure that no other use is made of the samples or information from the individual.

In one aspect of the invention, the protection service includes a value added package such as preparing a nucleotide sequence profile summary; preparing the nucleotide sequence and supplemental information for potential evaluation by the individual's medical practitioner; or referral to a genetic interpretation specialist.

In yet another embodiment of the invention, a method is provided for providing a personal nucleotide sequence copyright protection service to an individual, said method comprising:
a) entering into an agreement with an individual to provide services regarding the individual's personal nucleotide sequence for a fee;
b) obtaining a biological sample from the individual;
c) obtaining nucleotide sequence information from the biological sample;
d) storing and indexing the individual's nucleotide sequence information in a database record;
e) storing supplementary information regarding the individual in a way that associates the supplementary information with the individual's nucleotide sequence information;
f) maintaining the database;
g) retaining the biological sample, at least one polynucleotide sample derived therefrom, or any unused portions thereof, under conditions that preserve polynucleotides;
h) submitting an application for copyright registration of an expression of the individual's nucleotide sequence to the United States Copyright Office;
i) storing and indexing copyright information regarding the expression of the individual's nucleotide sequence in the individual's database record;
j) providing a value added package to the individual; wherein the service to the individual is provided by a service provider.

Typically, the step of nucleotide sequencing or polymorphism determination will provide sufficient information to permit unambiguous identification of the individual. In one aspect of this embodiment, the method may also comprise:
a) obtaining the individual's medical history record;
b) storing and indexing the medical history record in the individual's database record in a way that associates the medical record history with nucleotide sequence information and supplementary information about the individual;
c) obtaining permission from the individual to provide access to the individual's information in the database to third parties; and
d) providing access to the database to third parties, subject to confidentiality and anonymity restrictions.

Non-limiting examples of the suitable third parties include: medical researchers, pharmaceutical companies, government agencies and universities. Typically, the individual is compensated for permitting access to his database information.

The collection of compensation to either the service provider or the individual may be carried out in any desired manner. The compensation may a involve a lump sum payment. The compensation may also be paid out over a period of time. Furthermore, the compensation can be based upon a percentage of the individual's compensation received by permitting third parties to have access to his or her records and genetic information.

The invention will be further illustrated by reference to the following non-limiting Examples.

### EXAMPLES

### Example 1

### Analysis of SNP Nucleotide Sequence

Biological Samples. Blood samples were obtained from four individuals, anonymized and coded. The coded samples were transferred to Sequenom, Inc. for SNP analysis as detailed below.

SNP Analaysis. DNA was extracted from the coded blood samples using the PureGene™ DNA Purification kit (Gentra Systems, Minneapolis, Minn.) and analyzed for nucleotide sequence at 37 SNP locations using Sequenom's patented MassARRAY™ System of MALDI-TOF mass spectrometry using their proprietary MassEXTEND™ methodology (described in U.S. Pat. Nos. 6,602,662; 6,500,621; 6,428,955; 6,300,076; 6,277,573; 6,268,144; 6,258,538; 6,235,478; 6,221,605; 6,221,601; 6,197,498; 6,043,031; and 5,605,798; the entire disclosures of which are incorporated herein by reference).

Sequenom calculated that 35 SNPs would generate a human ID panel with equivalent resolving power to the standard 13 STR Promega panel widely used for uniquely identifying individuals. The 37 SNPs used in this assay were, therefore, an identifying number of polymorphisms, as defined herein. The error rate reported by Sequenom for the panel of 37 SNP was 1 in 2.4×10¹⁵.

The individual SNPs were selected based on the following criteria:
SNPs are unlinked (>50 cM apart)
Minor allele frequencies near 0.5 in the target populations
Not subject to selection or disease association
Preferably, outside of gene regions

The results of the analysis for the four individuals tested are given below in Table 1. demonstrating that each individual was found to have a unique pattern of nucleotide sequences based on the 37 SNP positions analyzed.

TABLE 1
SNP Analysis of DNA From Four Anonymous Individuals

| | | Indi- | Indi- | Indi- | Indi- |
|---|---|---|---|---|---|
| SNP ID | Alleles | vidual 1 | vidual 2 | vidual 3 | vidual 4 |
| 3277 | A/C | A, C | A, C | A | A |
| 9566 | C/T | T | T | T | T |
| 270487 | C/G | C | G | C | G |
| 276168 | C/T | C | C, T | C, T | C, T |
| 497523 | A/G | A, G | A, G | A | A |
| 731671 | C/T | C, T | T | C, T | T |
| 732098 | G/T | G | G | G | T |
| 732608 | C/T | C, T | T | C | C, T |
| 775709 | G/T | G, T | G, T | G | G |
| 848602 | C/T | C | T | C, T | C |
| 890978 | C/T | C | C | C | C |
| 910544 | C/G | C, G | C, G | G | G |
| 934774 | A/C | A, C | A | A, C | A |
| 975707 | C/G | G | C, G | C, G | C |
| 1035584 | A/G | A, G | A | G | A, G |
| 1042489 | C/T | T | C, T | C, T | T |
| 1052280 | C/T | C | T | C, T | C |
| 1055627 | A/G | G | A, G | A, G | A, G |
| 1129205 | G/A | G, A | A | A | G, A |
| 1231504 | A/G | A | G | G | A |
| 1461806 | A/G | A | A, G | G | A, G |
| 1513420 | A/G | A | A, G | G | G |
| 1573470 | A/G | G | G | G | A, G |
| 1582879 | A/G | A, G | A, G | G | A, G |
| 1632649 | A/G | G | G | G | A |
| 1672299 | C/T | T | T | C | C, T |
| 1836648 | A/G | A, G | A | A, G | A, G |
| 1874794 | C/T | C | C | C, T | C |
| 1912948 | C/T | C | T | T | T |
| 1950811 | A/C | A, C | A | C | A, C |
| 2271067 | C/T | C | C, T | C, T | T |
| 2273235 | A/C | A, C | A, C | A, C | A |
| 2282050 | C/G | C, G | C, G | G | G |
| 2292288 | C/T | C, T | C, T | C | C, T |
| 2613837 | G/T | G, T | G, T | T | G, T |
| 2853522 | A/C | A | A, C | A | C |
| 2943512 | G/T | T | G, T | G, T | G, T |

What is claimed is:

1. A method for providing a personal nucleotide sequence information protection service to an individual, said method comprising:
a) obtaining nucleotide sequence information for an individual;
b) entering the information into a database, and
c) seeking protection for the nucleotide sequence information; wherein steps a-c are carried out by a service provider.

2. The method of claim 1, wherein the individual is charged a fee.

3. The method of claim 1, wherein the step of obtaining nucleotide sequence information from an individual comprises:
obtaining a biological sample from the individual; and
analyzing the nucleotide sequence of at least one polynucleotide in the biological sample.

4. The method of claim 3, wherein obtaining nucleotide sequence information from an individual further comprises establishing and documenting the chain of custody of the biological sample and authenticity of the nucleotide sequence.

5. The method of claim 3, wherein the biological sample is selected from the group consisting of: a blood sample, a tissue sample, a saliva sample, a urine sample, and a hair sample.

6. The method of claim 3, wherein the polynucleotide is DNA.

7. The method of claim 3, wherein analyzing the nucleotide sequence of at least one polynucleotide in the sample comprises direct sequencing of at least an identifying number of nucleotides of the at least one polynucleotide.

8. The method of claim 3, wherein analyzing the nucleotide sequence of at least one polynucleotide in the sample comprises detecting at least an identifying number of polymorphisms.

9. The method of claim 3, wherein analyzing the nucleotide sequence of at least one polynucleotide in the sample provides sufficient information to allow identification of a propensity for a medical condition.

10. The method of claim 8, wherein detecting at least an identifying number of polymorphisms is performed using SSCP analysis, RFLP analysis, heteroduplex analysis; mass spectrometry, primer extension, a nucleic acid array or microarray, nucleic acid electrophoresis, nucleic acid hybridization, nucleic acid bending analysis, or a combination thereof.

11. The method of claim 8, wherein the polymorphisms are selected from the group of single nucleotide polymorphisms, restriction fragment length polymorphisms, and single tandem repeat polymorphisms.

12. The method of claim 8, wherein an identifying number of polymorphisms comprises at least 1 polymorphism.

13. The method of claim 8, wherein an identifying number of polymorphisms comprises at least 13 polymorphisms.

14. The method of claim 8, wherein an identifying number of polymorphisms comprises at least 18 polymorphisms.

15. The method of claim 8, wherein an identifying number of polymorphisms comprises at least 30 polymorphisms.

16. The method of claim 8, wherein an identifying number of polymorphisms comprises at least 70 polymorphisms.

17. The method of claim 3, wherein the biological sample, the at least one polynucleotide, or any unused portions thereof, is retained.

18. The method of claim 17, wherein the retained biological sample, polynucleotide or unused portions thereof, is stored under conditions that preserve polynucleotides.

19. The method of claim 1, wherein the database is a computer database and the entry of information creates a database record.

20. The method of claim 19, wherein the computer database record further comprises supplemental information about the individual.

21. The method of claim 20, wherein the supplemental information comprises at least one of: name, date of birth, contact information, sex, ethnic background, medical history, physical description and genealogy.

22. The method of claim 1, wherein the protection comprises legal protection, physical protection, or a combination thereof.

23. The method of claim 1, wherein the protection deters unauthorized conduct by third parties, wherein said unauthorized conduct comprises at least one of: use, misuse, distribution, duplication, reproduction, modification, derivation and commercial development of said nucleotide sequence information.

24. The method of claim 1, wherein the protection deters at least one of: false criminal accusations, improper denial of medical or insurance coverage, misidentification of the individual, misidentification of the individual's relatives, exploitation or commercialization of the individual's biological material without informed consent, and unauthorized cloning of the individual's cells, tissues, or genetic material.

25. The method of claim 22, wherein the legal protection comprises establishing a legal record of said identifying nucleotide sequence information.

26. The method of claim 25, wherein said record is useful for establishing the identity of the individual or a biological sample thereof.

27. The method of claim 26, wherein said record is useful for proving paternity, sibship, descendancy, national origin or ethnic origin of the individual.

28. The method of claim 22, wherein the legal protection comprises as least one of:
trade secret protection, patent protection and copyright protection.

29. The method of claim 28, wherein said copyright protection is characterized by fixing the nucleotide sequence information in a tangible medium of expression.

30. The method of claim 28, wherein the tangible medium of expression is a computer database record.

31. The method of claim 28, wherein the tangible medium of expression is selected from the group consisting of: a plaque, a certificate, an article of clothing, or an identification card.

32. The method of claim 28, wherein the copyright protection further comprises United States Copyright registration.

33. The method of claim 32, wherein the United States Copyright registration includes supplemental United States Copyright filings, wherein the supplemental United States Copyright filings seek protection for nucleotide polymorphisms detected in the individual's nucleotide sequence that were not protected by an earlier filing.

34. The method of claim 32, further comprising assigning the United States Copyright registration to the individual.

35. The method of claim 34, wherein the assignment is recorded with the United States Copyright Office.

36. The method of claim 34, wherein the assignment includes a retention by the assignee of the right to sublicense the copyright with the individual's consent.

37. The method of claim 28, wherein said trade secret protection comprises taking reasonable steps to maintain the secrecy of the nucleotide sequence information.

38. The method of claim 37, wherein said reasonable steps include at least one of:
anonymizing the sequence information, encrypting the database records, limiting access to the sequence information, requiring non-disclosure agreements of all personnel having access to the sequence information, and securing sequence information storage facilities.

39. The method of claim 28, wherein said patent protection involves isolating and purifying at least one patentable polynucleotide from the biological sample.

40. The method of claim 28, wherein said patent protection involves filing an application for patent with the United States Patent and Trademark Office.

41. The method of claim 22, wherein the physical protection comprises providing and maintaining a secure and confidential environment for the sequence information and retained biological samples.

42. The method of claim 41, wherein the secure and confidential environment is provided by anonymizing the sequence information, encrypting the database records, limiting access to the sequence information and biological samples, requiring non-disclosure agreements of all personnel having access to the sequence information the biological samples, and securing the sequence information and biological sample storage facilities from unauthorized entry.

43. The method of claim 1, wherein the individual is provided with a notice indicating the protected status of the individual's nucleotide sequence information.

44. The method of claim 43, wherein the notice may be distributed to prevent unauthorized use of the individual's DNA sample.

45. The method of claim 43, wherein the notice comprises copyright registration information on the nucleotide sequence

46. The method of claim 43, wherein the notice comprises a statement that the nucleotide sequence information is protected in a database.

47. The method of claim 43, wherein the notice comprises a statement that the nucleotide sequence information is protected by application for a patent.

48. A method for providing a nucleotide sequence information protection service to an individual, said method comprising:
a) entering into an agreement with the individual to provide protection services for a fee;
b) obtaining a biological sample from the individual;
c) obtaining nucleotide sequence information from the biological sample;
d) storing and indexing the nucleotide sequence information in a database record;
e) storing supplementary information regarding the individual in a way that associates the supplementary information with the nucleotide sequence information;
f) maintaining the database;
g) retaining the biological sample or any unused portion thereof, under conditions that preserve polynucleotides;
h) seeking protection of the nucleotide sequence information; and
i) providing a value added package to the individual, wherein the service to an individual is provided by a service provider.

49. The method of claim 48, wherein agreement with the individual includes the consent to provide a biological sample for nucleotide sequencing determination and the service provider documents individual's proof of personal identity.

50. The method of claim 48, wherein the agreement includes an agency grant from the individual to the service provider.

51. The method of claim 50, wherein the agency grant from the individual to the service provider allows handling, storage, administration, licensing and additional testing of the DNA sample.

52. The method of claim 48, wherein the step of storing and indexing the individual's nucleotide sequence information in a database record includes anonymizing the database record by assigning the individual an identification code to protect the individual's anonymity.

53. The method of claim 48, wherein the step of obtaining nucleotide sequence information from the biological sample comprises arranging for nucleotide sequencing or polymorphism determination by a third party.

54. The method of claim 53, wherein arranging for nucleotide sequencing or polymorphism determinantion by a third party includes: conveying the biological sample sample that is identified by the individual's identification code to a third party, and maintaining a chain of custody record for the sample.

55. The method of claim 48, wherein the value added package is selected from the group consisting of: preparing a nucleotide sequence profile summary, preparing the nucleotide sequence and supplemental information for potential evaluation by the individual's medical practitioner; and referral to a genetic interpretation specialist.

56. A method for providing a personal nucleotide sequence copyright protection service to an individual, said method comprising:
a) entering into an agreement with an individual to provide services regarding the individual's personal nucleotide sequence for a fee;
b) obtaining a biological sample from the individual;
c) obtaining nucleotide sequence information from the biological sample;
d) storing and indexing the nucleotide sequence information in a database record;
e) storing supplementary information regarding the individual in a way that associates the supplementary information with the nucleotide sequence information;
f) maintaining the database;
g) retaining the biological sample or any unused portion thereof, under conditions that preserve polynucleotides;
h) submitting an application for copyright registration of an expression of the individual's nucleotide sequence to the United States Copyright Office;
i) storing and indexing copyright information regarding the expression of the individual's nucleotide sequence in the individual's database record;
j) providing a value added package to the individual, wherein the service to an individual is provided by a service provider.

57. The method of claim 56, wherein agreement with the individual includes the consent to provide a biological sample for nucleotide sequencing determination and the service provider documents individual's proof of personal identity.

58. The method of claim 56, wherein the agreement includes an agency grant from the individual to the service provider.

59. The method of claim 58, wherein the agency grant from the individual to the service provider permits handling, storage, administration, licensing and additional testing of the biological sample.

60. The method of claim 56, wherein the step of storing and indexing the individual's nucleotide sequence information in a database record includes anonymizing the database record by assigning the individual an identification code to protect the individual's anonymity.

61. The method of claim 56, wherein the step of obtaining nucleotide sequence information from the biological sample comprises arranging for nucleotide sequencing or polymorphism determination by a third party.

62. The method of claim 61, wherein arranging for nucleotide sequencing or polymorphism determinantion by a third party includes: conveying the biological sample sample that is identified by the individual's identification code to a third party, and maintaining a chain of custody record for the sample.

63. The method of claim 56, wherein the value added package is selected from the group consisting of: preparing a nucleotide sequence profile summary, preparing the nucleotide sequence and supplemental information for potential evaluation by the individual's medical practitioner; and referral to a genetic interpretation specialist.

64. The method of claim 61, wherein the step of nucleotide sequencing or polymorphism determination provides sufficient information to permit unambiguous identification of the individual

65. The method of claim 56, further comprising:
a) obtaining the individual's medical history record;
b) storing and indexing the medical history record in the individual's database record in a way that associates the medical record history with nucleotide sequence information and supplementary information about the individual;
c) obtaining permission from the individual to provide access to the individual's information in the database to third parties; and
d) providing access to the database to third parties, subject to confidentiality and anonymity restrictions.

66. The method of claim 65, where said third party is a selected from the group consisting of: a medical researcher, a pharmaceutical company, a government agency, and a university.

67. The method of claim 65, wherein the individual receives compensation for permitting access to his database information.
